(19) United States
(12) Patent Application Publication
(10) Pub. No.: US 2015/0310978 A1
(43) Pub. Date: Oct. 29, 2015

(54) CHOKE

(71) Applicant: Delta Electronics Int'l (Singapore) Pte Ltd, Singapore (SG)

(72) Inventor: Da-Jung Chen, Singapore (SG)

(73) Assignee: Delta Electronics Int'l (Singapore) Pte Ltd, Singapore (SG)

(21) Appl. No.: 14/271,074

(22) Filed: May 6, 2014

(30) Foreign Application Priority Data
Apr. 28, 2014 (SG) 10201401882R

(51) Int. Cl. H01F 27/24; H01F 41/06

(52) U.S. Cl. CPC H01F 27/24; H01F 41/0612

(57) ABSTRACT

A choke includes a magnetic core including a winding portion, which has a first end and a second end, a first magnetic portion and a second magnetic portion and an insulated wire. A first angle and a second angle are respectively formed by the first magnetic portion and the winding portion and the second magnetic portion and the winding portion. The second angle is disposed opposite to the second angle. The insulated wire is wound on the winding portion for forming coil turns. The coil turns contacted with the winding portion is disposed at a first degree to the coil turns contacted with the first magnetic portion. The coil turns contacted with the winding portion is disposed at a second degree to the coil turns contacted with the second magnetic portion. The degree of the first angle and the degree of the second angle are greater than 90 degrees.

### TECHNICAL FIELD

The present disclosure relates to a choke, and more particularly to a choke that improves inductance distribution and avoids short circuit phenomena between coil turns.

### BACKGROUND

In lot types of electronic devices, the inductor and the choke are used for stabilizing the current and filtering the noise in a circuit, which are similar to the capacitor. The inductor, the choke and the capacitor are used for adjusting the stabilization of the current in manner of storing and releasing the electric energy of the circuit. The difference between the capacitor and the inductor and the choke is that the electric energy is stored by the capacitor in form of electric fields or stored by the inductor or the choke in form of magnetic fields.

Please refer to FIG. 1. FIG. 1 schematically illustrates a section view of a conventional choke according to the prior art. As shown in FIG. 1, the conventional choke 1 includes a magnetic core 10, a wire 11, a magnetic glue 12 and a couple of electrodes 13. The wire 11 is wound on the central post of the magnetic core 10 for forming coils, among which the larger the amounts of the coils are, the larger the inductance value is. After the coils are formed by winding the wire 11, the magnetic glue 12 is filled with the magnetic core 10 in a dispensing process, and then solidified in a baking process. After the electrodes 13 are manufactured in the final process, the classic conventional choke 1 is formed.

The structure and process of the conventional choke 1 mentioned above seem simple, but there are still some drawbacks, such as the short circuit issue between coils, the uneven range of the inductance distribution and the limitation of the application. Please refer to FIG. 2. FIG. 2 schematically illustrates a wire wound on the magnetic core of the conventional choke. As shown in FIG. 2, the wire 11 of the conventional choke 1 is usually enameled copper wire with its wire covered and protected by the outer enamel for insulating from the coils of wire 11. However, the edge of the magnetic core 10 usually has a right angle or an acute angle, so an abrasion or a breakage often occur when winding the wire 11 on the magnetic core 10, and further cause the short circuit phenomena between coils. Under this circumstance, the characteristics of the inductor and the choke cannot achieve the predicted performance, hence the product quality is decreased.

Moreover, because there exist differences of the size of the magnetic core 10 of the conventional choke 1, the wire tension of the wire 11 and the stability of the winding apparatus, the arrangement of the coils formed by the wire 11 may not achieve the predicted model when manufacturing the conventional choke 1. Please refer to FIG. 3A, FIG. 3B and FIG. 3C. FIG. 3A schematically illustrates a first abnormal arrangement of the coils formed by the wire. FIG. 3B schematically illustrates a second abnormal arrangement of the coils formed by the wire. FIG. 3C schematically illustrates a third abnormal arrangement of the coils formed by the wire. As shown in FIG. 3A, FIG. 3B and FIG. 3C, when the wire 11 is designed to be wound on the magnetic core 10 for forming 11 coils and the design arrangement of coils is from-left-to-right 3-4-4 and symmetrical 4-4-3 arranged, the practical arrangement of coils may be from-left-to-right 4-3-4 and 4-4-3 arranged as shown in FIG. 3A, from-left-to-right 1-3-4-3 and 3-3-3-2 arranged as shown in FIG. 3B, or from-left-to-right 2-2-3-4 and 3-3-3-2 arranged as shown in FIG. 3C. The amounts of coils under different arrangements are the same, but the inductance distribution is uneven.

Please refer to FIG. 4. FIG. 4 schematically illustrates a magnetic glue filled with the magnetic core of the conventional choke. As shown in FIG. 4, a magnetic glue 12 is filled with the magnetic core 10 in a dispensing process after forming coils through winding the wire 11 on the magnetic core 10 of the conventional choke 1. However, the inner coils cannot be effectively filled with or covered by the magnetic glue 12 due to the block of the outer coils, or even the inner coils are not filled with or covered by the magnetic glue 12. Not only the inductance is unstable, but also the inductance characteristics is poor. Meanwhile, in the final process, the electrodes 13 are formed on the bottom surface of the magnetic core 10 and the electrodes 13 are always facing down, so that the conventional choke 1 is limited in applications and cannot meet diverse demands of the applications.

There is a need of providing a choke to obviate the drawbacks encountered from the prior art.

### BRIEF SUMMARY

The present disclosure provides a choke in order to eliminate the drawbacks of the short circuit issue between coils caused by the abrasion, the uneven range of the inductance distribution caused by the unstable winding of the wire and the incomplete filling of the magnetic glue, and the limitation of the application.

The present disclosure also provides a choke. By the angles of the first magnetic portion and the winding portion, the angles of the second magnetic portion and the winding portion, and the guiding angles formed on the two sides of the first magnetic portion and the second magnetic portion, the present invention achieves the advantages of avoiding the abrasion of the insulated wire, enhancing the tolerance of the thermal impact, solving the short circuit issue of coil turns, and improving the product quality.

The present disclosure also provides a choke. Via the grooves, the bifacial electrodes and the pre-gluing process of a manufacturing method of the adhesive element, the inductance distribution is averaged, and the diverse demands of applications are met by the choke of the present invention.

In accordance with an aspect of the present disclosure, there is provided a choke. The choke includes a magnetic core and an insulated wire. The magnetic core includes a winding portion having a first end and a second end, a first magnetic portion connected with the first end of the winding portion for forming two first angles disposed opposite to each other with the winding portion, and a second magnetic portion connected with the second end of the magnetic portion for forming two second angles disposed opposite to each other with the winding portion. A winding space is defined by the first magnetic portion, the winding portion and the second magnetic portion, and the two second angles are disposed opposite to the two first angles in the winding space. The insulated wire is wound from the first magnetic portion or the second magnetic portion and wound on the winding portion from one of the first angles or one of the second angles in the winding space for forming a plurality of coil turns. The coil turns contacted with the winding portion are disposed at a first degree to the coil turns contacted with the first magnetic portion, and the coil turns contacted with the winding portion are disposed at a second degree to the coil turns contacted with the second magnetic portion. The degree of the first angle is greater than 90 degrees, and the degree of the second angle is greater than 90 degrees.

In accordance with another aspect of the present disclosure, there is provided a choke. The choke includes a magnetic core and an insulated wire. The magnetic core includes a winding portion having a first end and a second end, a first magnetic portion connected with the first end of the winding portion for forming two first angles disposed opposite to each other with the winding portion, and a second magnetic portion connected with the second end of the magnetic portion for forming two second angles disposed opposite to each other with the winding portion. The first magnetic portion includes a first side surface disposed opposite to the first end and a first trench and a second trench formed on the first side surface. The second magnetic portion includes a second side surface disposed opposite to the second end and a third trench and a fourth trench formed on the second side surface. A winding space is defined by the first magnetic portion, the winding portion and the second magnetic portion, and the two second angles are disposed opposite to the two first angles in the winding space. The insulated wire is formed as a first electrode in the third trench, formed as a second electrode in the first trench, wound on the winding portion from the first angle in the winding space for forming a plurality of coil turns, formed as a third electrode in the fourth trench, and formed as a fourth electrode in the second trench. The coil turns contacted with the winding portion are disposed at a first degree to the coil turns contacted with the first magnetic portion, and the coil turns contacted with the winding portion are disposed at a second degree to the coil turns contacted with the second magnetic portion. The degree of the first angle is greater than 90 degrees, and the degree of the second angle is greater than 90 degrees.

In accordance with another aspect of the present disclosure, there is provided a choke. The choke includes a magnetic core and an insulated wire. The magnetic core includes a winding portion having a first end and a second end, a first magnetic portion connected with the first end of the winding portion for forming two first angles disposed opposite to each other with the winding portion, and a second magnetic portion connected with the second end of the magnetic portion for forming two second angles disposed opposite to each other with the winding portion. The first magnetic portion includes a first side surface disposed opposite to the first end and a first trench and a second trench formed on the first side surface. The second magnetic portion includes a second side surface disposed opposite to the second end and a third trench and a fourth trench formed on the second side surface. A winding space is defined by the first magnetic portion, the winding portion and the second magnetic portion, and the two second angles are disposed opposite to the two first angles in the winding space. The insulated wire is formed as a first electrode in the first trench, wound on the winding portion from the first angle in the winding space for forming a plurality of coil turns, formed as a second electrode in the fourth trench, and formed as a third electrode in the second trench, wherein the first electrode is connected with a fourth electrode formed in the third trench by the insulated wire or another wire.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 schematically illustrates a section view of a conventional choke according to the prior art;

FIG. 2 schematically illustrates a section view of a wire wound on the magnetic core of the conventional choke;

FIG. 3A schematically illustrates a section view of a first abnormal arrangement of the coils formed by the wire;

FIG. 3B schematically illustrates a section view of a second abnormal arrangement of the coils formed by the wire;

FIG. 3C schematically illustrates a section view of a third abnormal arrangement of the coils formed by the wire;

FIG. 4 schematically illustrates a section view of a magnetic glue filled with the magnetic core of the conventional choke;

FIG. 5 schematically illustrates a section view of a choke according to an embodiment of the present invention;

FIG. 6 schematically illustrates a section view of a choke according to another embodiment of the present invention;

FIG. 7A schematically illustrates a section view of a magnetic glue filled with the insulated wire and the winding space as shown in FIG. 5.

FIG. 7B schematically illustrates the flow chart of a manufacturing method of an adhesive element according to an embodiment of the present invention;

FIG. 8A schematically illustrates a section view of the first magnetic portion and the second magnetic portion of the magnetic core and the first groove thereof of a choke according to an embodiment of the present invention;

FIG. 8B schematically illustrates a section view of the winding portion of the magnetic core and the first grooves thereof of a choke according to an embodiment of the present invention;

FIG. 9 schematically illustrates a section view of the magnetic core and the first grooves and the second grooves thereof of a choke according to an embodiment of the present invention;

FIG. 10A schematically illustrates a section view of the magnetic core and the first grooves thereof of a choke according to another embodiment of the present invention;

FIG. 10B schematically illustrates a section view of the magnetic core and first grooves and the second grooves thereof of a choke according to another embodiment of the present invention;

FIG. 11 schematically illustrates a section view of the choke and the electrodes thereof according to an embodiment of the present invention;

FIG. 12 schematically illustrates a section view of the choke and the electrodes thereof according to another embodiment of the present invention;

FIG. 13 schematically illustrates a section view of the choke and the electrodes thereof according to still another embodiment of the present invention;

FIG. 14 schematically illustrates a section view of the vertically stacked chokes of the present invention; and

FIG. 15 schematically illustrates a section view of a circuit board and an electronic component vertically stacked on the choke of the present invention.

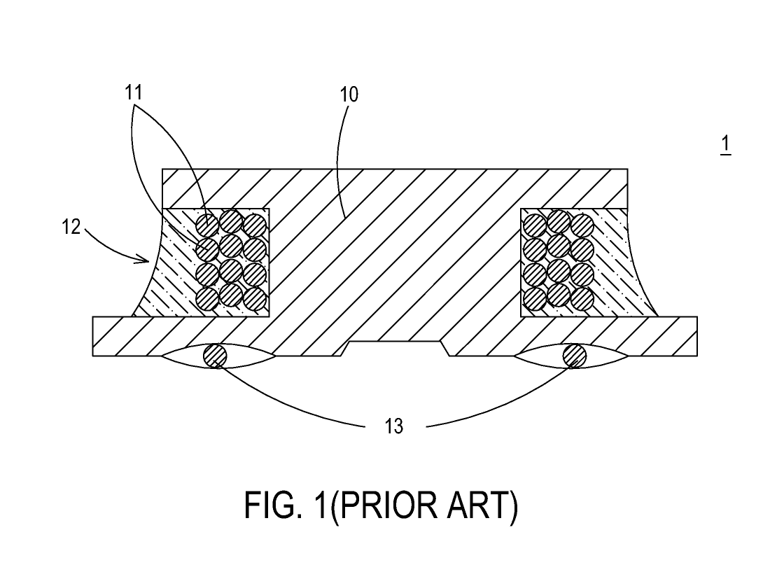

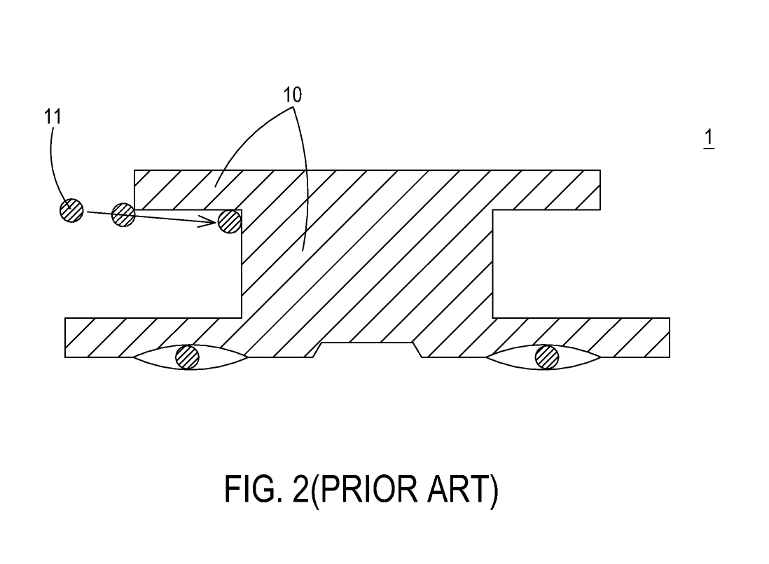

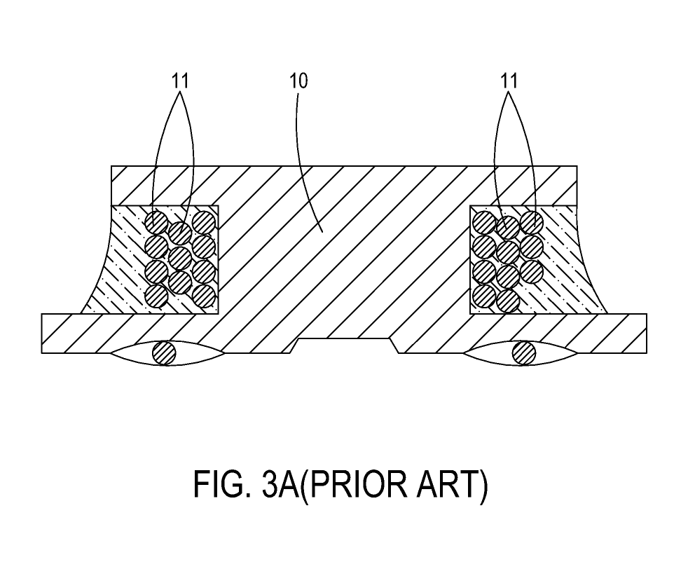

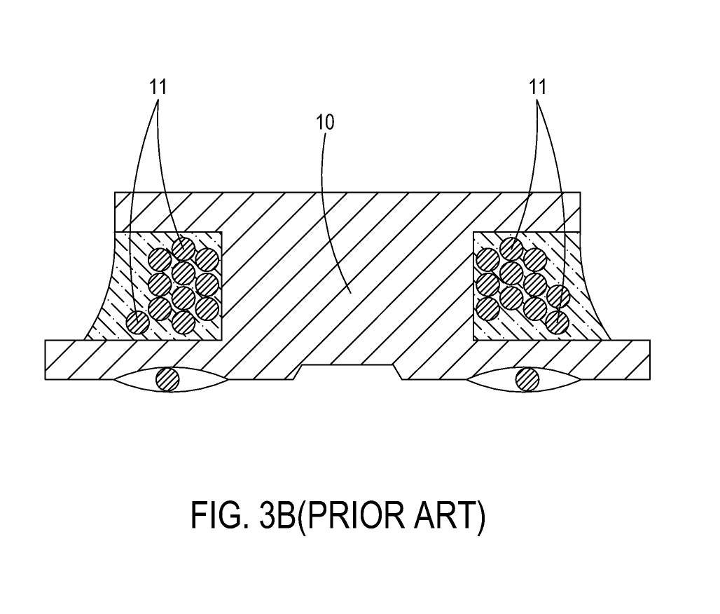

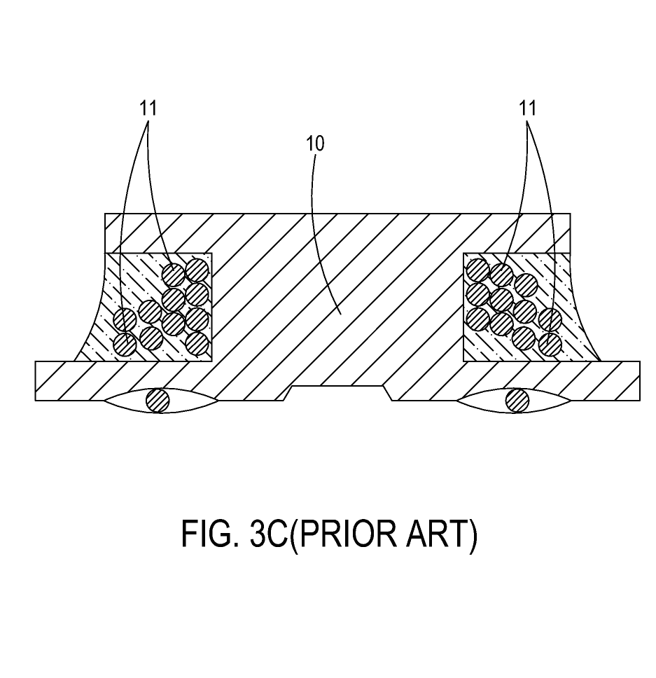

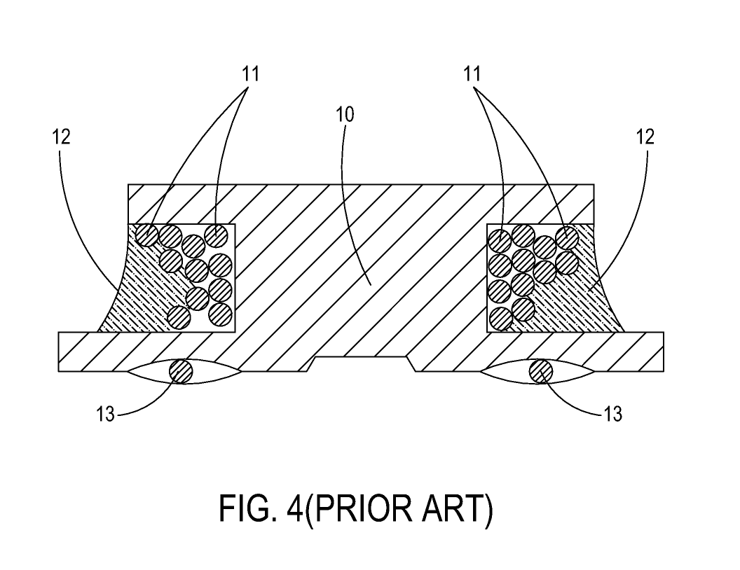

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

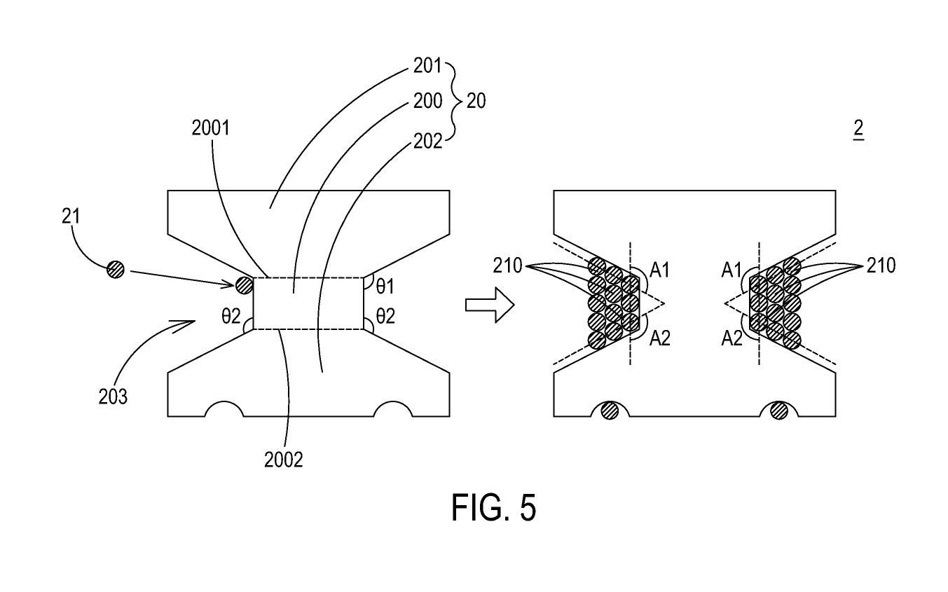

Please refer to FIG. 5. FIG. 5 schematically illustrates a section view of a choke according to an embodiment of the present invention. As shown in FIG. 5, a choke 2 of the present invention includes a magnetic core 20 and an insulated wire 21, among which the insulated wire 21 is not limited to an enamel copper wire. The magnetic core 20 includes a winding portion 200 having a first end 2001 and a second end 2002, a first magnetic portion 201 and a second magnetic portion 202. The first magnetic portion 201 is connected with the first end 2001 of the winding portion 200 for forming two first angles θ1 disposed opposite to each other with the winding portion 200. The second magnetic portion 202 is connected with the second end 2002 of the winding portion 200 for forming two second angles θ2 disposed opposite to each other with the winding portion 200. A winding space 203 is defined by the first magnetic portion 201, the winding portion 200 and the second magnetic portion 202, and the two second angles θ2 are disposed opposite to the two first angles θ1 in the winding space 203.

The insulated wire 21 is wound from the first magnetic portion or the second magnetic portion, and is wound on the winding portion 200 from one of the first angles θ1 or one of the second angles θ2 in the winding space 203 for forming a plurality of coil turns 210. The coil turns 210 contacted with the winding portion 200 are disposed at a first degree A1 to the coil turns 210 contacted with the first magnetic portion 210, and the coil turns 210 contacted with the winding portion 200 are disposed at a second degree A2 to the coil turns 210 contacted with the second magnetic portion 202. In this embodiment, the degree of the first angle and the degree of the second angle are greater than 90 degrees.

In some embodiments, the degree of the first angle θ1 is preferred to be equal to the degree of the second angle θ2 for improving the inductance performance and equilibrium. Under this circumstance, the first magnetic portion 201 and the second magnetic portion 202 are configured as inclined planes relative to the magnetic portion 200, so that the insulated wire 21 is guided to be wound on the magnetic portion 200 with avoiding the abrasion of the insulated wire 21. In addition, the degree of each of the first angle θ1 is equal to the first degree A1, and the degree of each of the second angle θ2 is equal to the second degree A2, so that the coil turns 210 is closely arranged along the winding portion 200, the first magnetic portion 201 and the second magnetic portion 202.

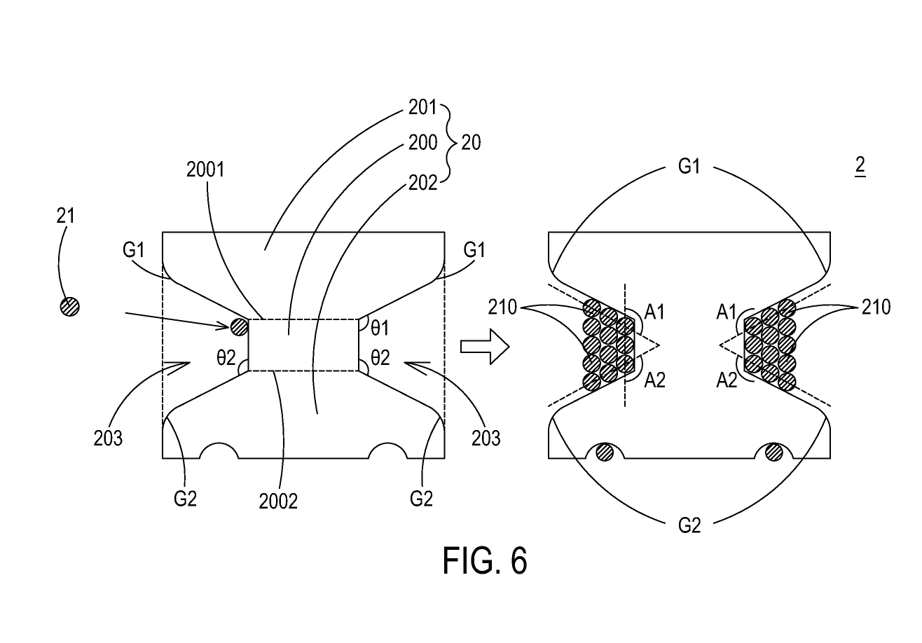

Please refer to FIG. 6. FIG. 6 schematically illustrates a section view of a choke according to another embodiment of the present invention. As shown in FIG. 6, the first magnetic portion 201 of the magnetic core 20 of the choke 2 of the present invention further includes two first guiding angles G1. The two first guiding angles G1 are formed on two sides of the first magnetic portion 201, disposed adjacent to the winding space 203 and opposite to each other for guiding the insulated wire 21 to wound on the magnetic portion 200 that avoids the abrasion of the insulated wire 21 and the short circuit of the coil turns 210. Certainly, the second magnetic portion 202 may further include two second guiding angles G2. The two second guiding angles G2 are formed on two sides of the second magnetic portion 202, disposed adjacent to the winding space 203 and opposite to each other for guiding the insulated wire 21 to wound on the magnetic portion 200 from another side that avoids the abrasion of the insulated wire 21. In some embodiments, the first magnetic portion 201 and the second magnetic portion 202 of the magnetic core 20 simultaneously include the first guiding angles G1 and the second guiding angles G2, respectively, or only the first magnetic portion 201 or the second magnetic portion 202 includes the first guiding angles G1 or the second guiding angles G2.

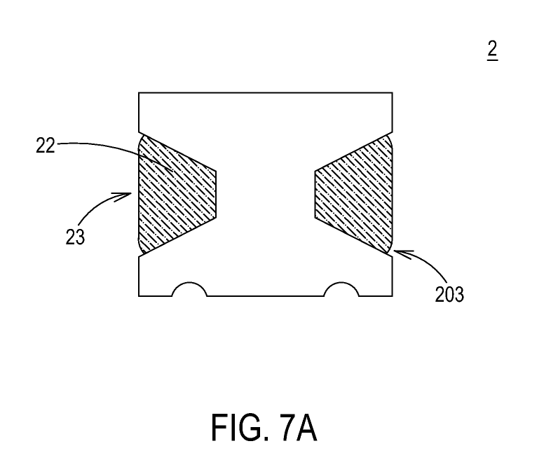

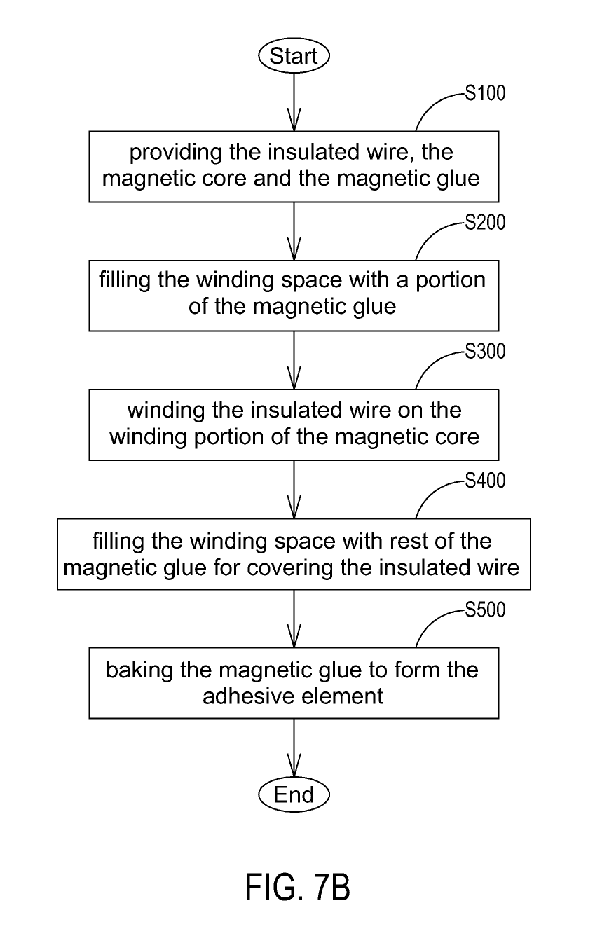

Please refer to FIG. 5 and FIG. 7A. FIG. 7A schematically illustrates a section view of a magnetic glue filled with the insulated wire and the winding space as shown in FIG. 5. As shown in FIG. 5 and FIG. 7A, the choke 2 of the present invention further includes a magnetic glue 22. The magnetic glue 22 is filled with the winding space 203 for covering the insulated wire 21 and the plurality of the coil turns 210 thereof to form an adhesive element 23. The first magnetic portion 201 and the second magnetic portion 202 of the magnetic core 20 are configured as inclined planes relative to the magnetic portion 200, so the angles of the adhesive element 23 located on the first angles θ1 and the second angles θ2 are not right angles, which scatters the stress in a relatively larger degree, such that the tolerance of the thermal impact of the choke 2 is enhanced. In brief, by the angles of the first magnetic portion 201 and the winding portion 200, the angles of the second magnetic portion 202 and the winding portion 200, and the guiding angles formed on the two sides of the first magnetic portion 201 and the second magnetic portion 202, the present invention achieves the advantages of avoiding the abrasion of the insulated wire 21, enhancing the tolerance of the thermal impact, solving the short circuit issue of coil turns 210, and improving the product quality. Moreover, the first degree A1 is matched with the first angle θ1 and the second degree A2 is matched with the second angle θ2, so that the coil turns 210 is closely arranged along the winding portion 200, the first magnetic portion 201 and the second magnetic portion 202. Therefore, not only the insulated wire is perfectly accommodated, but also the problems and the drawbacks of fixing of prior art are solved.

In another embodiment, for avoiding the issue that the winding space 203 and the insulated wire 21 and the coil turns 210 thereof cannot be effectively filled with the magnetic glue 22 as prior art, the present disclosure provides a manufacturing method of the adhesive element 23. Please refer to FIG. 7B. FIG. 7B schematically illustrates the flow chart of a manufacturing method of an adhesive element according to an embodiment of the present invention. The manufacturing method of the adhesive element 23 includes steps as follows. At first, providing the insulated wire 21, the magnetic core 20 and the magnetic glue 22 as shown in step S100. Next, filling the winding space 203 with a portion of the magnetic glue 22 to at least partially distribute the magnetic glue 22 on the winding portion 200 of the magnetic core 20 as shown in step S200, among which the step of filling the winding space 203 with the portion of the magnetic glue 22 is configured as a pre-gluing process. Then, winding the insulated wire 21 on the winding portion 200 of the magnetic core 20 for allowing the insulated wire 21 to uniformly contact with the portion of the magnetic glue 22 as shown in step S300. Next, filling the winding space 203 with rest of the magnetic glue 22 for completely covering the insulated wire 21 and the coil turns 210 thereof as shown in step S400. Finally, baking the magnetic glue 22 to form the adhesive element 23 as shown in step S500. Via the pre-gluing process of the manufacturing method of the adhesive element of the present invention, the inductance distribution is averaged.

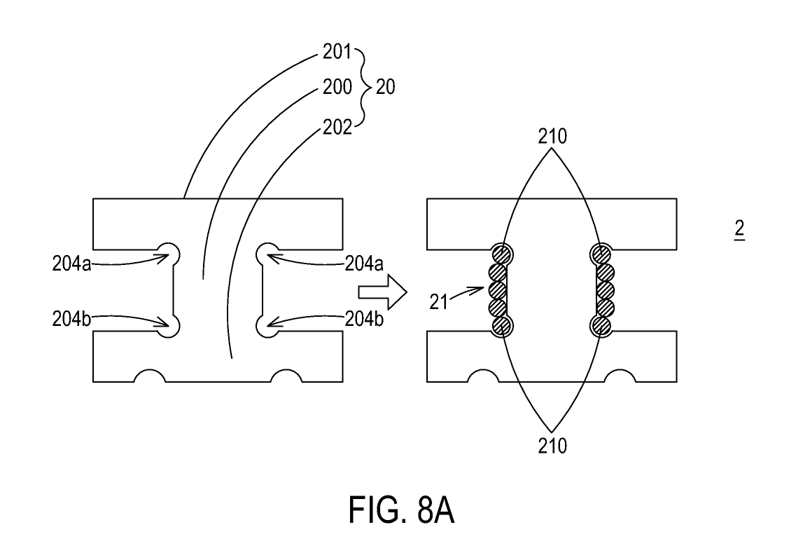

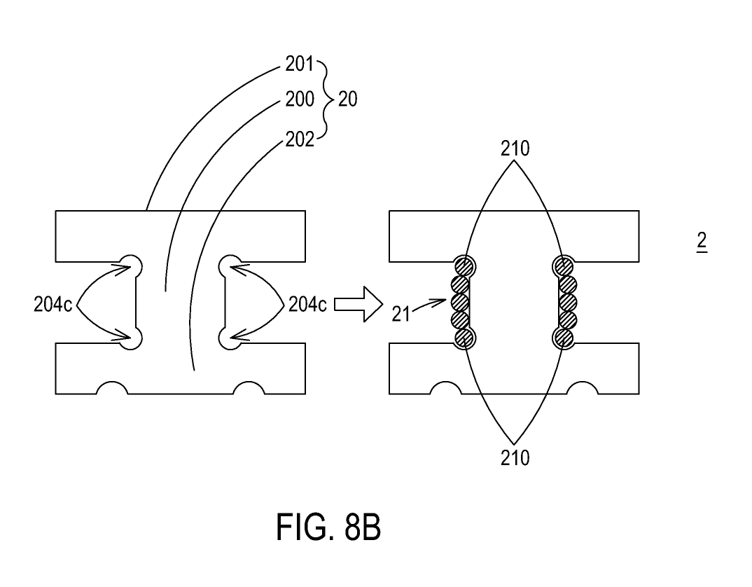

Please refer to FIG. 8A. FIG. 8A schematically illustrates a section view of the first magnetic portion and the second magnetic portion of the magnetic core and the first groove thereof of a choke according to an embodiment of the present invention. As shown in FIG. 8A, the first magnetic portion 201 of the magnetic core 20 of the choke 2 of the present invention includes a first groove 204a, and the first groove 204a is annularly formed on the two first angles θ1 for receiving at least one coil turn 210 of the plurality of the coil turns 210 of the insulated wire 21. Moreover, the second magnetic portion 202 may also include a first groove 204b, and the first groove 204b is annularly formed on the two second angles θ2 for receiving at least one coil turn 210 of the plurality of the coil turns 210 of the insulated wire 21. Therefore, the insulated wire 21 is located through the first grooves 204a, 204b to stably form the coil turns 210.

On the other hand, in the equivalent embodiments, please refer to FIG. 8B. FIG. 8B schematically illustrates a section view of the winding portion of the magnetic core and the first grooves thereof of a choke according to an embodiment of the present invention. The magnetic portion 200 of the magnetic core 20 of the choke 2 of the present invention includes two first grooves 204c, and the two first grooves 204c are respectively formed on the two first angles θ1 and the two second angles θ2 for receiving at least two coil turns 210 of the plurality of the coil turns 210 of the insulated wire 21. That is, at least two coil turns 210 are respectively accommodated in the two first grooves 204c located on the two first angles θ1 and the two first grooves 204c located on the two second angles θ2, but not limited thereto.

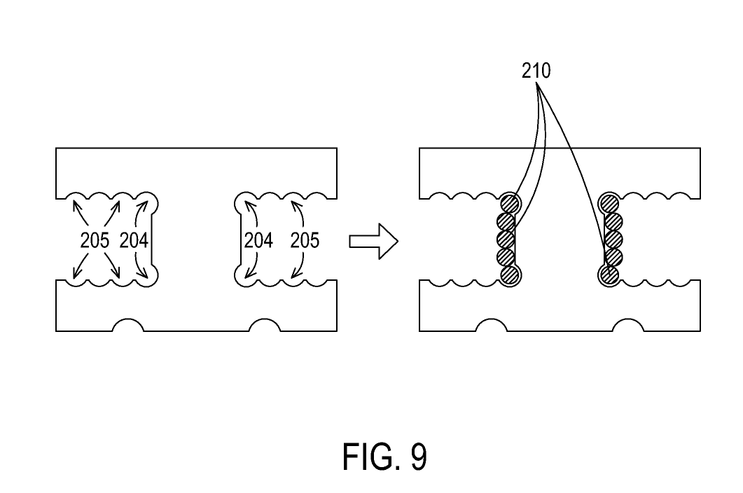

Please refer to FIG. 9. FIG. 9 schematically illustrates a section view of the magnetic core and the first grooves and the second grooves thereof of a choke according to an embodiment of the present invention. As shown in FIG. 9, the first magnetic portion 201 and the second magnetic portion 202 further include at least one second groove 205. The second groove 205 is disposed adjacent to the first groove 204, and each second groove 205 is used for receiving a coil turn 210 of the plurality of the coil turns 210 of the insulated wire 21.

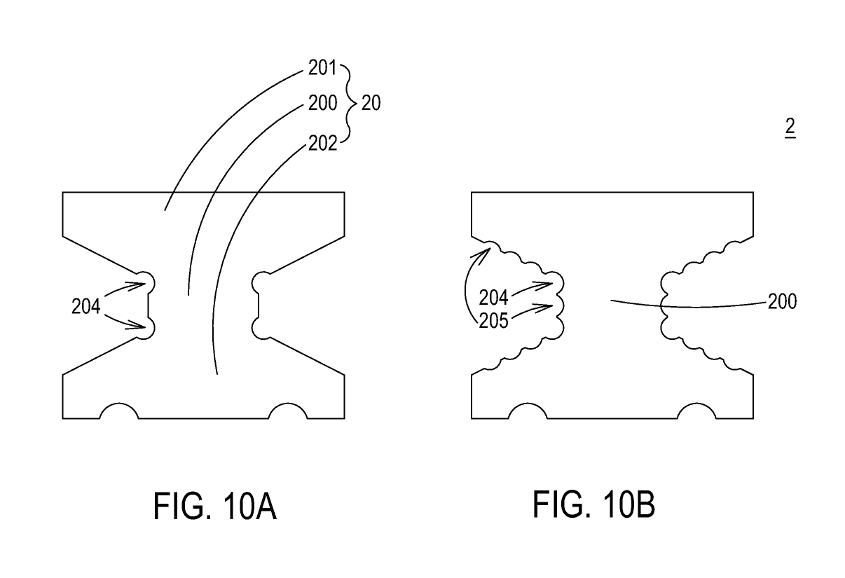

Certainly, the concept of the second groove 205 can be extended and utilized on the magnetic portion 200. Please refer to FIG. 10A and FIG. 10B. FIG. 10A schematically illustrates a section view of the magnetic core and the first grooves thereof of a choke according to another embodiment of the present invention. FIG. 10B schematically illustrates a section view of the magnetic core and first grooves and the second grooves thereof of a choke according to another embodiment of the present invention. As shown in FIG. 10A and FIG. 10B, the magnetic portion 200 of the magnetic core 20 of the choke 2 of the present invention further includes at least one second groove 205. The second groove 205 is disposed adjacent to the first groove 204, and each second groove 205 is used for receiving a coil turn 210 of the plurality of the coil turns 210 of the insulated wire 21. As a result, via the auxiliary locating first grooves 204 and second groove 205, the plurality of coil turns 210 are tightly and stably formed, such that the inductance distribution is averaged.

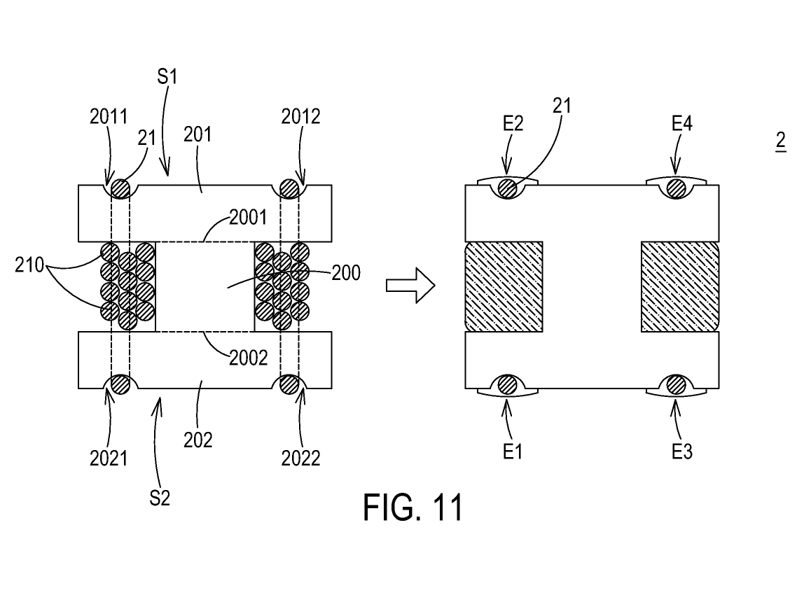

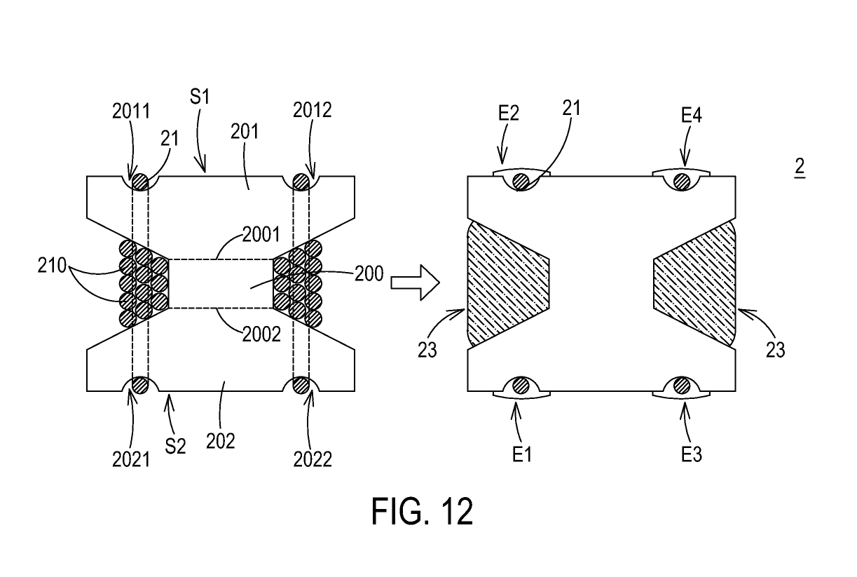

Please refer to FIG. 11 and FIG. 12. FIG. 11 schematically illustrates a section view of the choke and the electrodes thereof according to an embodiment of the present invention. FIG. 12 schematically illustrates a section view of the choke and the electrodes thereof according to another embodiment of the present invention. As shown in FIG. 11 and FIG. 12, the first magnetic portion 201 includes a first side surface S1 disposed opposite to the first end 2001 and a first trench 2011 and a second trench 2012 formed on the first side surface S1, and the second magnetic portion 202 includes a second side surface S2 disposed opposite to the second end 2002 and a third trench 2021 and a fourth trench 2022 formed on the second side surface S2. In this embodiment, the first trench 2011 is disposed opposite to the third trench 2021, and the second trench 2012 is disposed opposite to the fourth trench 2022. The insulated wire 21 is formed as a first electrode E1 in the third trench 2021, formed as a second electrode E2 in the first trench 2011, wound on the winding portion 200 from the first angle θ1 in the winding space 203 to form the coil turns 210, formed as a third electrode E3 in the fourth trench 2022, and formed as a fourth electrode E4 in the second trench 2012. Finally, the insulated wire 21 is spot welded and cut at the fourth electrode E4. Therefore, the first electrode E1 and the second electrode E2 have the same electric potential, and the third electrode E3 and the fourth electrode E4 have the same electric potential.

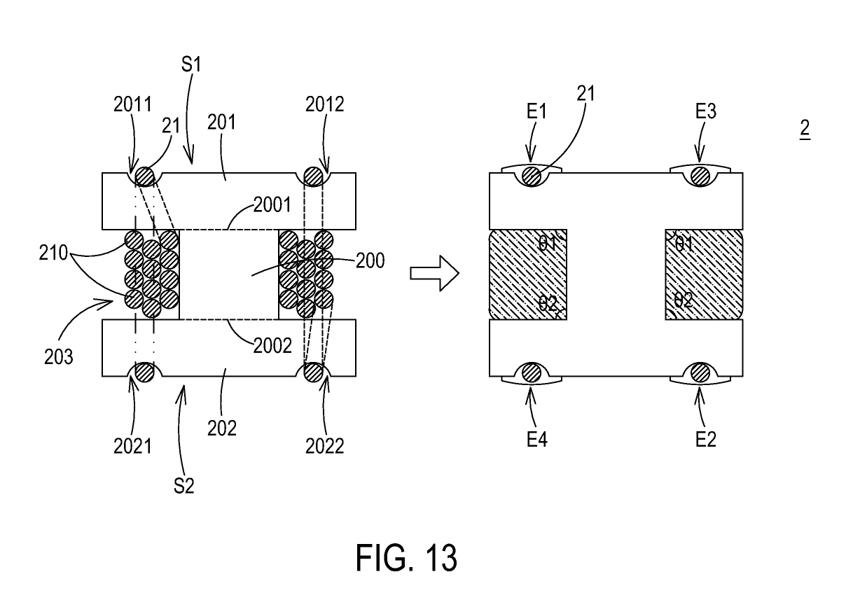

Please refer to FIG. 13. FIG. 13 schematically illustrates a section view of the choke and the electrodes thereof according to still another embodiment of the present invention. As shown in FIG. 13, the first magnetic portion 201 includes a first side surface S1 disposed opposite to the first end 2001 and a first trench 2011 and a second trench 2012 formed on the first side surface S1, and the second magnetic portion 202 includes a second side surface S2 disposed opposite to the second end 2002 and a third trench 2021 and a fourth trench 2022 formed on the second side surface S2. In this embodiment, the first trench 2011 is disposed opposite to the third trench 2021, and the second trench 2012 is disposed opposite to the fourth trench 2022. The insulated wire 21 is formed as a first electrode E1 in the first trench 2011, wound on the winding portion 200 from the first angle θ1 in the winding space 203 to form the coil turns 210, formed as a second electrode E2 in the fourth trench 2022, and formed as a third electrode E3 in the second trench 2012. The insulated wire 21 is spot welded and cut at the third electrode E3. Finally, the first electrode E1 is connected with a fourth electrode E4 formed in the third trench 2021 by the insulated wire 21 or another wire, among which the fourth electrode E4 may be preformed in the third trench 2021 or be formed in the third trench 2021 after the third electrode E3 is formed, but not limited thereto.

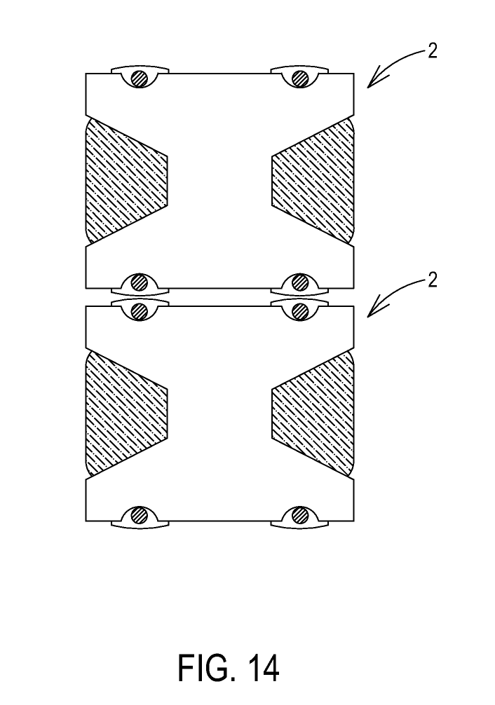

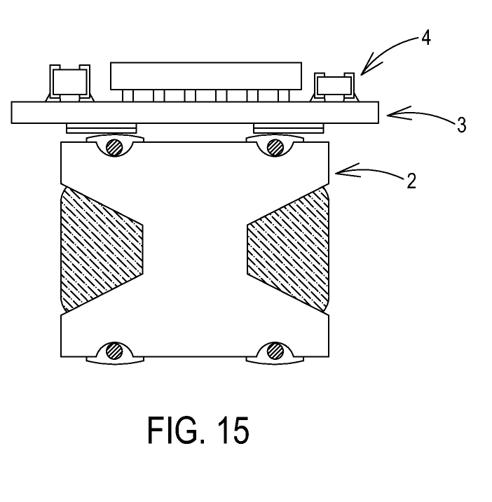

Please refer to FIG. 14 and FIG. 15. FIG. 14 schematically illustrates a section view of the vertically stacked chokes of the present invention. FIG. 15 schematically illustrates a section view of a circuit board and an electronic component vertically stacked on the choke of the present invention. As shown in FIG. 14 and FIG. 15, the choke 2 of the present invention not only has electrodes on the bottom surface, but also has electrodes on the top surface corresponding to the electrodes on the bottom surface. A plurality of the chokes 2 can be utilized so as to be vertically stacked, or a circuit board and an electronic component can be vertically stacked on the choke 2 of the present invention. Compared with the conventional chokes, the choke 2 of the present invention is not limited in one direction anymore but can be utilized for meeting diverse demands of applications.

From the above description, the present disclosure provides a choke. By the angles of the first magnetic portion and the winding portion, the angles of the second magnetic portion and the winding portion, and the guiding angles formed on the two sides of the first magnetic portion and the second magnetic portion, the present invention achieves the advantages of avoiding the abrasion of the insulated wire, enhancing the tolerance of the thermal impact, solving the short circuit issue of coil turns, and improving the product quality. Meanwhile, via the grooves, the bifacial electrodes and the pre-gluing process of a manufacturing method of the adhesive element, the inductance distribution is averaged, and the diverse demands of applications are met by the choke of the present invention.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A choke, comprising:
a magnetic core comprising:
a winding portion having a first end and a second end;
a first magnetic portion connected with the first end of the winding portion for forming two first angles disposed opposite to each other with the winding portion; and
a second magnetic portion connected with the second end of the magnetic portion for forming two second angles disposed opposite to each other with the winding portion, wherein a winding space is defined by the first magnetic portion, the winding portion and the second magnetic portion, and the two second angles are disposed opposite to the two first angles in the winding space; and
an insulated wire wound from the first magnetic portion or the second magnetic portion and wound on the winding portion from one of the first angles or one of the second angles in the winding space for forming a plurality of coil turns, wherein the coil turns contacted with the winding portion are disposed at a first degree to the coil turns contacted with the first magnetic portion, and the coil turns contacted with the winding portion are disposed at a second degree to the coil turns contacted with the second magnetic portion,
wherein the degree of the first angle is greater than 90 degrees, and the degree of the second angle is greater than 90 degrees.

2. The choke according to claim 1, wherein the first magnetic portion further comprises two first guiding angles, and wherein the two first guiding angles are formed on two sides of the first magnetic portion, disposed adjacent to the winding space and opposite to each other.

3. The choke according to claim 1, wherein the second magnetic portion further comprises two second guiding angles, and wherein the two second guiding angles are formed on two sides of the second magnetic portion, disposed adjacent to the winding space and opposite to each other.

4. The choke according to claim 1, wherein the degree of each of the first angle is equal to the first degree, and the degree of each of the second angle is equal to the second degree.

5. The choke according to claim 1, wherein the degree of the first angle is equal to the degree of the second angle.

6. The choke according to claim 1, wherein the magnetic portion includes two first grooves, and wherein the two first grooves are respectively formed on the two first angles and the two second angles for receiving at least two coil turns of the plurality of the coil turns of the insulated wire.

7. The choke according to claim 6, wherein the magnetic portion further includes at least one second groove, and wherein the second groove is disposed adjacent to the first groove, and each second groove is used for receiving a coil turn of the plurality of the coil turns of the insulated wire.

8. The choke according to claim 1, wherein the first magnetic portion includes a first groove, and wherein the first groove is annularly formed on the two first angles for receiving at least one coil turn of the plurality of the coil turns of the insulated wire.

9. The choke according to claim 8, wherein the first magnetic portion further includes at least one second groove, and wherein the second groove is disposed adjacent to the first groove, and each second groove is used for receiving a coil turn of the plurality of the coil turns of the insulated wire.

10. The choke according to claim 1, wherein the first magnetic portion includes a first side surface disposed opposite to the first end and a first trench and a second trench formed on the first side surface, and the second magnetic portion includes a second side surface disposed opposite to the second end and a third trench and a fourth trench formed on the second side surface.

11. The choke according to claim 10, wherein the insulated wire is formed as a first electrode in the third trench, formed as a second electrode in the first trench, wound on the winding portion from the first angle in the winding space to form the coil turns, formed as a third electrode in the fourth trench, and formed as a fourth electrode in the second trench.

12. The choke according to claim 1, wherein the second magnetic portion includes a first groove, and wherein the first groove is annularly formed on the two second angles for receiving at least one coil turn of the plurality of the coil turns of the insulated wire.

13. The choke according to claim 12, wherein the second magnetic portion further includes at least one second groove, and wherein the second groove is disposed adjacent to the first groove, and each second groove is used for receiving a coil turn of the plurality of the coil turns of the insulated wire.

14. The choke according to claim 1 further comprising a magnetic glue, wherein the magnetic glue is filled with the winding space for covering the insulated wire to form an adhesive element.

15. The choke according to claim 14, wherein a manufacturing method of the adhesive element comprises steps of:
providing the insulated wire, the magnetic core and the magnetic glue;
filling the winding space with a portion of the magnetic glue to at least partially distribute the magnetic glue on the winding portion of the magnetic core;
winding the insulated wire on the winding portion of the magnetic core for allowing the insulated wire to uniformly contact with the portion of the magnetic glue;
filling the winding space with rest of the magnetic glue for covering the insulated wire; and
baking the magnetic glue to form the adhesive element.

16. The choke according to claim 15, wherein the step of filling the winding space with the portion of the magnetic glue is configured as a pre-gluing process.

17. A choke, comprising:
a magnetic core comprising:
a winding portion having a first end and a second end;
a first magnetic portion connected with the first end of the winding portion for forming two first angles disposed opposite to each other with the winding portion, wherein the first magnetic portion includes a first side surface disposed opposite to the first end and a first trench and a second trench formed on the first side surface; and
a second magnetic portion connected with the second end of the magnetic portion for forming two second angles disposed opposite to each other with the winding portion, wherein a winding space is defined by the first magnetic portion, the winding portion and the second magnetic portion, and the two second angles are disposed opposite to the two first angles in the winding space, and wherein the second magnetic portion includes a second side surface disposed opposite to the second end and a third trench and a fourth trench formed on the second side surface; and
an insulated wire formed as a first electrode in the third trench, formed as a second electrode in the first trench, wound on the winding portion from the first angle in the winding space to form a plurality of coil turns, formed as a third electrode in the fourth trench, and formed as a fourth electrode in the second trench,
wherein the coil turns contacted with the winding portion are disposed at a first degree to the coil turns contacted with the first magnetic portion, and the coil turns contacted with the winding portion are disposed at a second degree to the coil turns contacted with the second magnetic portion, and wherein the degree of the first angle is greater than 90 degrees, and the degree of the second angle is greater than 90 degrees.

18. The choke according to claim 17, wherein the first electrode and the second electrode have the same electric potential, and the third electrode and the fourth electrode have the same electric potential.

19. The choke according to claim 17, wherein the first trench is disposed opposite to the third trench, and the second trench is disposed opposite to the fourth trench.

20. A choke, comprising:
a magnetic core comprising:
a winding portion having a first end and a second end;
a first magnetic portion connected with the first end of the winding portion for forming two first angles disposed opposite to each other with the winding portion, wherein the first magnetic portion includes a first side surface disposed opposite to the first end and a first trench and a second trench formed on the first side surface; and
a second magnetic portion connected with the second end of the magnetic portion for forming two second angles disposed opposite to each other with the winding portion, wherein a winding space is defined by the first magnetic portion, the winding portion and the second magnetic portion, and the two second angles are disposed opposite to the two first angles in the winding space, and wherein the second magnetic portion includes a second side surface disposed opposite to the second end and a third trench and a fourth trench formed on the second side surface; and
an insulated wire formed as a first electrode in the first trench, wound on the winding portion from the first angle in the winding space to form a plurality of coil turns, formed as a second electrode in the fourth trench, and formed as a third electrode in the second trench, wherein the first electrode is connected with a fourth electrode formed in the third trench by the insulated wire or another wire.
